(19) United States
(12) Patent Application Publication
(10) Pub. No.: US 2026/0277201 A1
(43) Pub. Date: Sep. 17, 2026

(54) METHOD FOR READJUSTING A MANUFACTURING PROCESS

(71) Applicant: TRUMPF Werkzeugmaschinen SE + Co. KG, Ditzingen (DE)

(72) Inventor: Stephan Niessner, Illertissen (DE)

(21) Appl. No.: 19/670,032

(22) Filed: May 7, 2026

Related U.S. Application Data
(63) Continuation of application No. PCT/EP2024/082381, filed on Nov. 14, 2024.

(30) Foreign Application Priority Data
Nov. 17, 2023 (DE) 10 2023 132 049.1

(51) Int. Cl. G05B 19/418; G06Q 50/04

(52) U.S. Cl. CPC G05B 19/41865; G06Q 50/04; G05B 2219/33034

(57) ABSTRACT

A method readjusts a separating/forming process, including the steps of: providing parameter values of control parameters for controlling manufacturing means; providing workpiece parameters for characterizing the workpiece and specifying target values of the workpiece parameters which the workpiece should have after separation; controlling the manufacturing means by the machine controller based on the control parameters to carry out a separation step; measuring separating forces and/or travel occurring during separation; evaluating values of the separating forces and/or travel using an evaluation model to determine actual parameter values of the workpiece parameters; determining readjustment values of the control parameters based on the actual parameter values determined using a prediction model, such that the readjustment values during separation of the workpiece minimize a difference between the target values and the actual parameter values, the difference being determined after the provided separation steps; and readjusting the control parameters to the readjustment values.

### CROSS REFERENCE TO RELATED APPLICATIONS

This application is a continuation of International Application No. PCT/EP2024/082381 (WO 2025/104187 A1), filed on Nov. 14, 2024, and claims benefit to German Patent Application No. DE 10 2023 132 049.1, filed on Nov. 17, 2023. The aforementioned applications are hereby incorporated by reference herein.

### FIELD

The present disclosure relates to a method for readjusting a separating process and/or forming process, wherein "separation" according to the present disclosure is understood in particular to mean a partial separation of a workpiece, in particular the at least partial, preferably complete, severing of a workpiece.

### BACKGROUND

A readjustment method has become known from DE 10 2019 216 315 A1 in connection with a laser processing system for processing a workpiece. The workpiece is processed by the laser processing system under a laser processing condition (for example, a movement of the processing head). A machine learning device of the laser processing system is trained in the process to predict a suitable laser processing condition in each case for desired temperature distributions in the workpiece. For this purpose, simulation results and measured data on different temperature distributions in the workpiece during laser processing are used.

DE 10 2017 109 713 A1 relates to a roll-forming stand with a sensor for measuring a force which the roll-forming stand exerts on a metal sheet during its forming process. A detector algorithm is designed to use the sensor signal to identify the state (in particular wear) of the roll-forming stand in order to display the state to a user of the roll-forming stand.

To readjust separating processes, it is known to change the settings of manufacturing means used to carry out such a separating process by comparing target values with measured values of positions or reference variables of the manufacturing means. It is also known that such readjustments can also be made by adapting characteristic variables of the separating process to the separating process within the framework of adaptive control.

With known methods, the effects of deviations of a specific workpiece to be separated and/or of the manufacturing means from specified standards on the separating or forming process often cannot be taken into account with sufficient accuracy.

### SUMMARY

In an aspect, the present disclosure provides a method for readjusting a separating process and/or forming process, including the steps of: I. providing a workpiece; II. providing a manufacturing means for separating the workpiece; III. providing separation steps for separating the workpiece; IV. providing parameter values of control parameters for controlling the manufacturing means; V. providing workpiece parameters for characterizing the workpiece and specifying target values of the workpiece parameters which the workpiece should have after separation; VI. storing the parameter values of the control parameters in a machine controller; VII. controlling the manufacturing means by the machine controller based on the control parameters to carry out a separation step from the provided separation steps; VIII. measuring separating forces and/or travel occurring during separation during the separation step; IX. evaluating values of the separating forces and/or travel measured in step VIII using an evaluation model to determine actual parameter values of the workpiece parameters for characterizing the workpiece; X. determining readjustment values of the control parameters based on the actual parameter values of the workpiece parameters determined in step IX using a prediction model, such that, within a framework of a calculation by the prediction model, the readjustment values of the control parameters during separation of the workpiece minimize a difference between the target values of the workpiece parameters and the actual parameter values of the workpiece parameters of the workpiece, the difference being determined after the provided separation steps have been carried out; XI. readjusting the control parameters to the readjustment values; and XII. repeating steps VI to XI until the provided separation steps have been carried out.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a side view of a separation system according to the present disclosure;

FIG. 2 shows the separation system in the schematic side view, in which a specified separation step is carried out according to the present disclosure;

FIG. 3 shows the separation system in a schematic side view after the specified separation step has been carried out according to the present disclosure; and

FIG. 4 schematically shows the workflow of the method according to the present disclosure.

### DETAILED DESCRIPTION

Aspects of the present disclosure provide a method for readjusting a separating process in which the effect of the manufacturing means on the workpiece during the separating process can be precisely taken into account.

An aspect of the present disclosure provides a method for readjusting a separating process which has the following steps:

I. providing a workpiece;

II. providing a manufacturing means for separating the workpiece;

III. providing separation steps for separating the workpiece;

IV. providing parameter values of control parameters for controlling the manufacturing means;

V. providing workpiece parameters for characterizing the workpiece and specifying target values of the workpiece parameters which the workpiece should have after separation;

VI. storing the parameter values of the control parameters in a machine controller;

VII. controlling the manufacturing means by the machine controller by means of the control parameters to carry out a separation step from the provided separation steps;

VIII. measuring the separating forces and/or travel occurring during separation during the separation step;

IX. evaluating the values of the separating forces and/or travel measured in step VIII using an evaluation model in order to determine actual parameter values of the workpiece parameters for characterizing the workpiece;

X. determining readjustment values of the control parameters by means of the actual parameter values of the workpiece parameters determined in step IX using a prediction model, such that, within the framework of the calculation by the prediction model, the readjustment values of the control parameters during separation of the workpiece minimize a difference between the target values of the workpiece parameters and the actual parameter values of the workpiece parameters of the workpiece, the difference being determined after the provided separation steps have been carried out;

XI. readjusting the control parameters to the readjustment values;

XII. repeating steps VI to XI until the provided separation steps have been carried out.

By evaluating the forces and travel occurring during separation within the separation step, precise statements can be made about the actual parameter values of the workpiece parameters of the workpiece being separated. The prediction model can then calculate precise parameter values of the control parameters with which the desired separation of the workpiece is achieved by the specifically used manufacturing means and the specifically used workpiece. This allows the manipulated variables of the separating process to be precisely set depending on the workpiece and the manufacturing means. The two-stage controller in the form of the evaluation model and the prediction model allows the separating process to be flexibly adapted to different workpieces and manufacturing means. The separating process can be adapted if the workpiece on which the separating process is carried out and/or the manufacturing means deviate(s) comparatively strongly from specified characteristics (such as a specified sheet thickness). The calculation of the parameter values of the control parameters, adapted to the specific workpiece, leads to a high product quality of the manufactured workpiece. Furthermore, adapting the parameter values of the control parameters to the workpiece reduces the risk of damage to the manufacturing means in an automated separating process. By evaluating the forces and travel occurring in the separation step, continuous monitoring of the separating process is possible.

The term manufacturing means refers in particular to the tool or semi-finished product that acts on the workpiece to carry out the separating process. Deviations from standards can occur, for example, due to wear and tear on the manufacturing means.

Statements relating to the separation of the workpiece within the context of the application may also generally apply to a manufacturing process, in particular to forming, of the workpiece within the context of a method according to the present disclosure.

According to an advantageous aspect of the method, the following steps are carried out after step XII:

XIII. measuring the actual parameter values of the workpiece parameters of the workpiece;

XIV. determining differences between the measured actual parameter values of the workpiece parameters and the target values of the workpiece parameters;

XV. determining the readjustment values of the control parameters by means of the differences determined in step XIV using the prediction model, such that, within the framework of the calculation by the prediction model, the readjustment values of the control parameters during separation according to the provided separation steps minimize a difference between the target values of the workpiece parameters and the actual parameter values of the workpiece parameters, the difference being determined after the provided separation steps have been carried out;

XVI. readjusting the control parameters to the readjustment values;

XVII. carrying out steps I to XII, wherein, in step I, a further workpiece is provided and, in step IV, the control parameters readjusted to the readjustment values in step XVI are provided.

It is advantageous to check the finished workpiece again after separation for deviations from the desired result of the separating process. This allows the separating accuracy of subsequent workpieces to be further improved. This applies in particular to manufacturing defects that the workpiece as a whole has after separation (global manufacturing defects).

In an advantageous aspect, the workpiece parameters have flatness parameters to characterize the flatness of a workpiece, wherein the target values of the flatness parameters have desired parameter values of the flatness parameters in order to achieve a desired flatness of the workpiece after the provided separation steps have been carried out. The flatness is determined in particular according to the standard DIN EN ISO 1101. Flatness parameters can be, for example, parameters that specify the curvature of a workpiece surface and/or the deviations from a plane through the workpiece surface.

In a preferred aspect of the method, the prediction model has a neural network, in particular a multi-layer perceptron. A multi-layer perceptron (MLP) is particularly suitable for making predictions from data sets, in particular in the case of non-linear relationships between the workpiece parameters and the control parameters.

In a further development of the aforementioned aspect, the prediction model is trained in the following steps:
i. determining first parameter values of the workpiece parameters of a test workpiece and determining parameter values of the control parameters before the subsequent step, step ii, is carried out;
ii. initializing weights in the prediction model;
iii. separating the test workpiece by means of the manufacturing means by changing the first parameter values to the second parameter values of the workpiece parameters;
iv. measuring the parameter values of the control parameters after step iii has been carried out;
v. calculating predicted parameter values of the control parameters for separating the test workpiece by changing the first parameter values to the second parameter values of the workpiece parameters using the prediction model;
vi. calculating the difference between the predicted parameter values of the control parameters and the parameter values of the control parameters measured in step iv;
vii. updating the weights in the prediction model to minimize the difference according to step vi;
viii. repeating steps v to vii until the defect according to step vi reaches a specified minimization limit.

An advantageous aspect of the method is one in which the evaluation model has an algorithm for evaluating the forces and/or travel measured during separation of the workpiece, a decision tree, a decision forest, which can also be called a random forest, and/or a neural network to classify the workpiece into a workpiece class belonging to specified workpiece classes and/or to classify the manufacturing means into a manufacturing means class belonging to specified manufacturing means classes. The neural network can interact with the decision tree or decision forest, for example, in particular in identifying relevant branches of a decision tree for classifying the workpiece. The neural network can be designed as the algorithm with which the aforementioned measured forces and/or travel are evaluated, or interact with this algorithm.

According to a preferred aspect of the method, the evaluation model is selected from a group of evaluation models, in particular on the basis of the parameter values of the control parameters provided in step III and/or on the basis of parameter values of the workpiece parameters provided in step IV. This allows the evaluation model to be precisely coordinated with the type of workpiece and/or manufacturing means in order to accelerate and/or refine the evaluation. Different materials or geometries of the workpieces and/or manufacturing means may require different algorithms to evaluate the forces and/or travel occurring during separation. In particular, this can reduce the uncertainty of probabilistic calculations of the evaluation model.

In an advantageous aspect of the method, the prediction model is selected from a group of prediction models before step X, in particular on the basis of the parameter values of the control parameters provided in step III and/or on the basis of the parameter values of the workpiece parameters provided in step IV. This allows the prediction of the subsequent readjustment values of the control parameters to be accelerated and/or refined. Different workpieces and/or manufacturing means may necessitate the use of different neural networks.

An advantageous aspect of the method is one in which, before step X, the machine controller compares the parameter values determined in step IX with target values of the control parameters and/or workpiece parameters. This allows for a time-saving check as to whether the desired workpieces and/or manufacturing means are used during separation. The target values of the workpiece parameters can match the desired values of the workpiece parameters completely or partially.

In an advantageous aspect of the method, the control parameters has a force with which the manufacturing means acts on the workpiece, geometric parameters of the manufacturing means and/or path parameters of a path along which the manufacturing means is guided.

In a preferred aspect of the method, the workpiece parameters compromise material parameters of a material of the workpiece, geometric parameters of the workpiece, in particular a thickness of the workpiece and/or a shear strength of the workpiece.

A further aspect of the method is characterized by the fact that the workpiece parameters have cut surface parameters to characterize the quality of a cut surface, wherein the target values have desired parameter values of the cut surface parameters for a desired quality of the cut surface, and, in step X, readjustment values of the control parameters are determined by means of the parameter values of the workpiece parameters determined in step IX using the prediction model or a further prediction model in such a way that a difference between the target values of the cut surface parameters and the parameter values of the cut surface parameters of the workpiece is minimized after the provided separation steps have been carried out. The predictions of the prediction model and/or the further prediction model allow for a particularly precise design of the cut surface. The further prediction model can be designed as a neural network, in particular as a multi-layer perceptron. The training of the further neural network can be carried out according to the steps described above for training the neural network.

In a preferred aspect of the method, the separating process and/or forming process is designed as a punching process. The method enables particularly precise punching of a workpiece.

Further advantages of the present disclosure are evident from the description and the drawing. Similarly, the features mentioned above and the features still to be explained may each be used on their own or together in any desired combinations according to the present disclosure. The embodiments shown and described in the figures should not be understood as an exhaustive list, but rather are of an exemplary character.

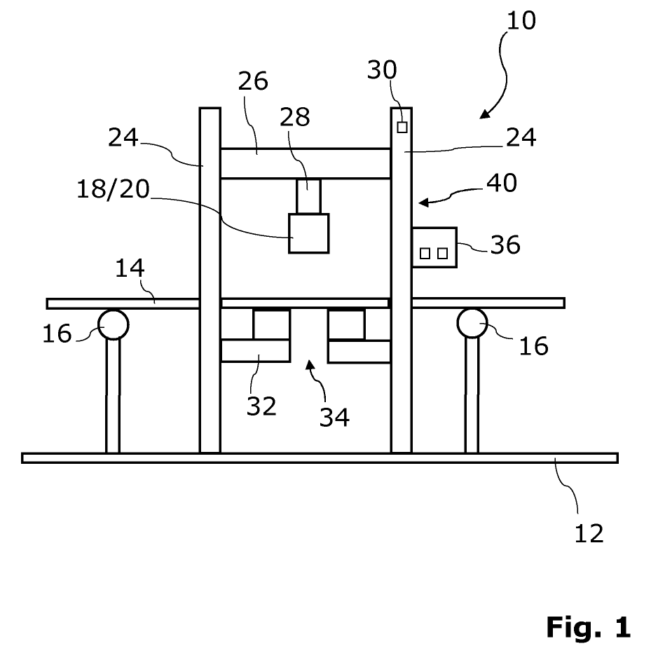

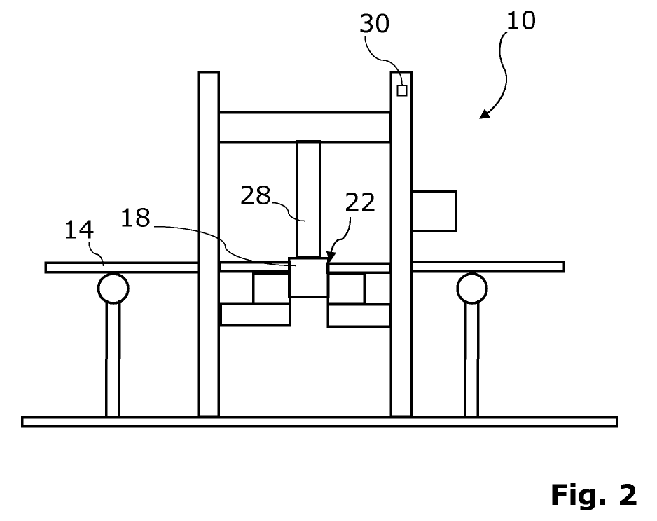

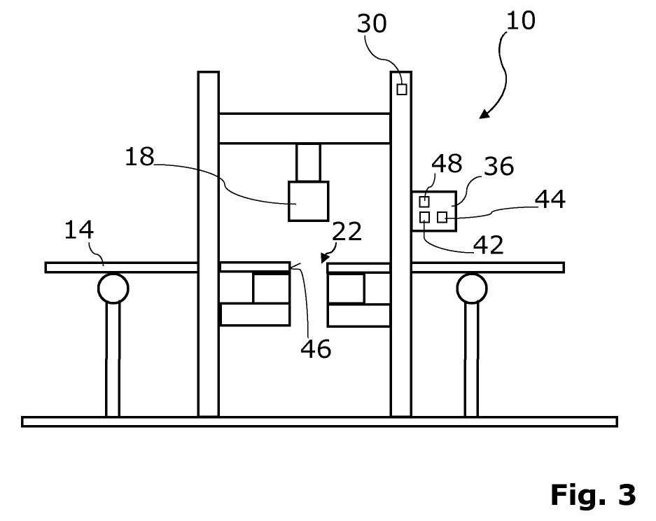

FIG. 1 schematically shows a side view of a separation system 10, which is positioned on a base 12. A workpiece 14 in the form of a metal sheet is transported on transport rollers 16 of the separation system 10. Alternatively or additionally to the transport rollers 16, brush tables of the separation system 10 can be used. In the embodiment shown, the separation system 10 is designed as a punching machine. The separation system 10 has a manufacturing means 18 which is designed in particular as a tool or a semi-finished product. In the embodiment shown, the manufacturing means 18 has a punch 20 by which cut-outs 22 (see FIGS. 2 and 3) are punched into the workpiece 14. A frame 40 of the separation system 10 is designed with two vertically oriented supports 24 and a horizontal support 26, the horizontal support 26 being disposed between the vertical supports 24 and attached to the vertical supports 26. A stroke rod 28 is mounted in the horizontal support 26 and is movable vertically. The stroke rod 28 holds the manufacturing means 18, which can be moved together with the lifting rod 28 to punch the workpiece 14. Alternatively, the frame 40 can also be C-shaped according to the present disclosure.

A sensor 30 is arranged in the separation system 10, which is configured to measure forces occurring during the separating process according to the present disclosure and/or to measure paths traveled during the separating process, in particular travel of the manufacturing means 18. The sensor 30 can also have a different position suitable for measuring forces and/or paths. A die 32 of the separation system 10 is formed with a cavity 34 through which the punched-out parts of the workpiece 14 are removed. A machine controller 36 of the separation system 10 is used to control a separating process according to the disclosure.

The separating process consists of a sequence of separation steps, which are defined before separation and, in particular, stored in the machine controller 36. Control parameters are used to control the manufacturing means 18, and the parameter values of these control parameters are stored in the machine controller 36. These parameter values define the actions of the manufacturing means 18 during the individual separation steps. The control parameters can have a force with which the manufacturing means 18 acts on the workpiece 14, geometric parameters of the manufacturing means 18, and/or path parameters of a path along which the manufacturing means 18 is guided.

The properties of the workpiece 14 are encoded in parameter values of the workpiece parameters, and the workpiece parameters are defined before the workpiece 14 is separated. The workpiece parameters can have material parameters of a material of the workpiece 14, geometric parameters of the workpiece 14, in particular a thickness of the workpiece 14, and/or a shear strength of the workpiece 14. At the start of an method according to the present disclosure, values of the workpiece parameters are specified as parameter values which are typical for the type of workpiece 14 which is to be separated. Furthermore, target values of the workpiece parameters, which the workpiece 14 should have after separation by the specified separation steps, are stored in the machine controller 36.

FIG. 2 shows the separation system 10 in a schematic side view, with one of the specified separation steps being carried out. The manufacturing means 18 is moved downwards in a vertical direction on the stroke rod 28 and punches a cut-out 22 (see FIG. 3) into the workpiece 14. The sensor 30 in the manufacturing means 18 measures separating forces occurring during separation and/or travel covered by the manufacturing means 18 during separation.

FIG. 3 shows the separation system 10 in a schematic side view after the specified separation step has been carried out (see FIG. 2). The workpiece 14 has the cut-out 22 punched by the manufacturing means 18. The forces and/or travel measured by the sensor 30 while the separation step is carried out are evaluated using an evaluation model 42 which is stored in the machine controller 36. Alternatively or additionally to the use of a machine controller 36, the models mentioned and/or data used in the application can be stored according to the present disclosure in an external computing unit. The evaluation determines actual parameter values of the workpiece parameters, which define the properties of the specific workpiece 14 on which the separation step was carried out. In the case of deviations, the specified parameter values of the workpiece parameters of the workpiece 14 are replaced by the actual parameter values. The deviations of the actual parameter values of the workpiece parameters from the specified parameter values can arise, among other things, from fluctuations in the thickness of the workpiece 14 or from differences between the actual material of the workpiece 14 and the desired material.

A prediction model 44 stored in the machine controller 36 determines readjustment values of the control parameters on the basis of the actual parameter values of the workpiece parameters. The readjustment values of the control parameters are determined in such a way that, during execution of the further separation steps, a difference between the target values of the workpiece parameters and the parameter values of the workpiece parameters of the workpiece 14 is minimized after the provided separation steps have been carried out. The control parameters are set to the readjustment values. This allows, for example, wear and tear on the manufacturing means 18 to be taken into account. Subsequently, a further separation step is carried out and the control parameters are readjusted in the manner described above until all specified separation steps have been carried out.

The workpiece parameters can have, in particular, cut surface parameters to characterize the quality of a cut surface 46 that is produced during separation. The prediction model 44 and/or a further prediction model 48, which is stored in the machine controller 36, can be used to determine readjustment values of the control parameters in such a way that a difference between target values of the cut surface parameters and actual parameter values of the cut surface parameters of the workpiece 14 is minimized after the provided separation steps have been carried out.

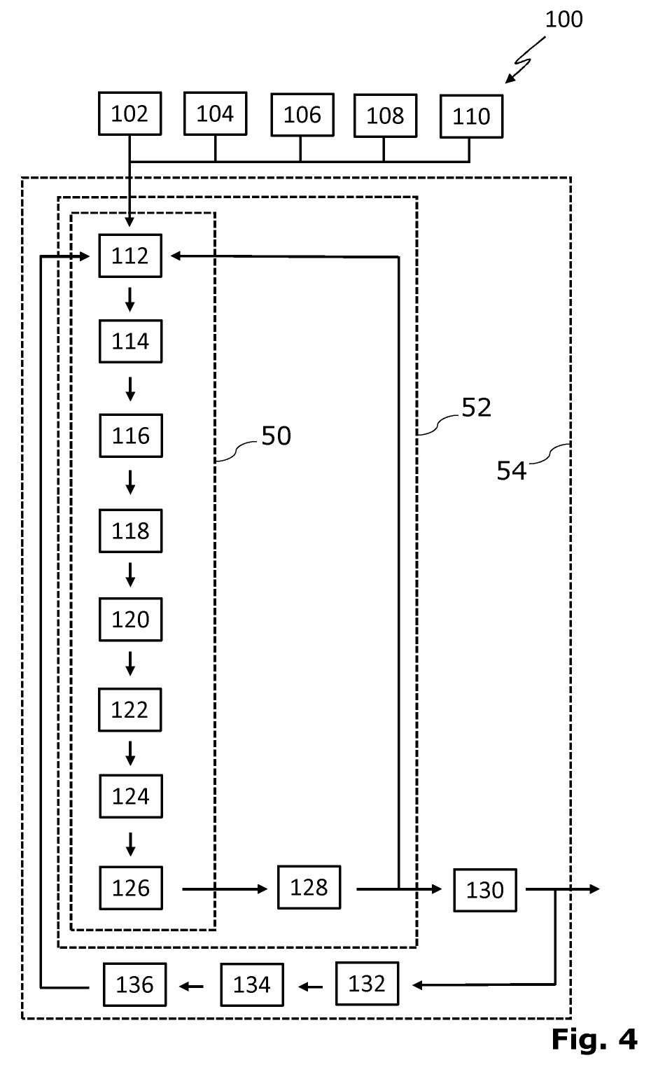

FIG. 4 schematically shows the separation of the workpiece 14 (see FIG. 1) and readjustment of the control parameters within the framework of the method 100 according to the present disclosure. In a first sub-step 102, the workpiece 14 is provided. In a second sub-step 104, the manufacturing means 18 is provided for separating the workpiece 14. In a third sub-step 106, separation steps for separating the workpiece 14 are specified. In a fourth sub-step 108, parameter values of the control parameters for controlling the manufacturing means 18 are made available while the individual separation steps are carried out. In a fifth sub-step 110, the workpiece parameters for characterizing the workpiece 14 are defined and target values for these workpiece parameters are specified which the workpiece parameters should have after separation of the workpiece 14. The aforementioned sub-steps can be carried out sequentially or in parallel.

In a sixth sub-step 112, the parameter values of the control parameters are stored in the machine controller 36. In a seventh step 114, the manufacturing means 18 is controlled within a specified separation step by the control parameters stored in the machine controller 36 in order to separate the workpiece 14. In an eighth sub-step 116, the travel and forces occurring during this separation are measured by the sensor 30 in the manufacturing means 18. In an optional ninth sub-step 118, an evaluation model 42 is selected from a group of evaluation models 42 (see FIG. 3) to evaluate the measurement signals measured in the eighth sub-step 116. The selection of the evaluation model 42 is made in particular on the basis of the parameter values of the workpiece parameters, the control parameters, the type of workpiece 14 and/or the type of manufacturing means 18.

In a tenth sub-step 120, the measurement signals measured in the eighth sub-step 116 are evaluated using the evaluation model 42, which may have been previously selected from a group of evaluation models 42 in the optional ninth sub-step 118. This involves determining the actual parameter values of the workpiece parameters. During the evaluation using the evaluation model 42, interference components of the measurement signals from the eighth sub-step 116 are preferably removed. The evaluation model 42 has, in particular, an algorithm for evaluating the measurement signals and/or a decision tree for classifying the workpiece and/or the manufacturing means. Alternatively or additionally to the decision tree, the evaluation model 42 can have a decision forest. Alternatively or additionally to a decision tree and/or decision forest, other suitable assessment models can be used according to the present disclosure. Preferably, the evaluation model 42 has a neural network, which can be combined, in particular, with a decision tree, for example to accelerate classifications.

In an optional eleventh sub-step 122, the actual parameter values of the workpiece parameters ascertained using the evaluation model 42 are compared with target values of the workpiece parameters, and these target values can in particular correspond to the target values of the workpiece parameters. This comparison can ascertain whether the desired workpiece 14 and/or the desired manufacturing means 18 is being used.

In an optional twelfth sub-step 124, a prediction model 44 is selected from a group of prediction models 44 (see FIG. 3) in order to determine the readjustment values of the control parameters on the basis of the actual parameter values of the workpiece parameters determined in the tenth sub-step (see below). The selection of the prediction model 44 is made in particular on the basis of the parameter values of the workpiece parameters, the control parameters, the actual parameter values of the workpiece parameters, the type of workpiece 14 and/or the type of manufacturing means 18.

In a thirteenth sub-step 126, the actual parameter values of the workpiece parameters ascertained using the evaluation model 42 are made available to the prediction model 44. The prediction model 44 is configured to determine readjustment values of the control parameters in such a way that the control parameters set to the readjustment values minimize the difference between the target values of the workpiece parameters and the actual parameter values of the workpiece parameters of the workpiece 14. This difference is determined after the separating process has been carried out, in particular after the specified separation steps have been carried out. For this purpose, the prediction model 44 preferably has a neural network, in particular a multi-layer perceptron.

In particular, step 126 can also be used to determine the quality of the cut surface 46 (see FIG. 3) which was produced as part of a separating process according to the seventh sub-step 114. This determination can be carried out using the prediction model 44 or the further prediction model 48 (see FIG. 3), and the further prediction model 48 particularly preferably also has a neural network which was trained according to analogous steps as the prediction model 44, and parameters relevant for the training of the further prediction model are used to determine the quality of the cut surface. In particular, as part of the step 126, feedback on the quality of the cut surface 46 can be provided, for example to the machine controller 36. Preferably, the machine controller 36 provides the feedback to a user of the method.

In a fourteenth sub-step 128, the control parameters are set to the readjustment values. The aforementioned sub-steps from the sixth sub-step 112 to the fourteenth sub-step 128 are repeated for each specified separation step until all specified separation steps have been completed. In a fifteenth sub-step 130, the separated finished part is made available for further processing or for its intended use after the specified separation steps are carried out.

After the predetermined separation steps have been carried out, the following further sub-steps can optionally be performed to achieve a separation for further workpieces that better matches the target specifications (in the form of the target values of the workpiece parameters): the parameter values of the workpiece parameters of the workpiece 14 are determined according to a sixteenth sub-step 132 after the specified separation steps have been carried out on the workpiece. Then, according to a seventeenth sub-step 134, the difference between the parameter values of the workpiece parameters determined in the sixteenth sub-step 132 and the target values of the workpiece parameters is calculated. Then, according to an eighteenth sub-step 136, the readjustment values of the control parameters of the manufacturing means 18 are defined using the prediction model 44 in such a way that, within the framework of the calculation by the prediction model 44, a difference between the target values of the workpiece parameters and the actual parameter values of the workpiece parameters of the workpiece 14 is minimized.

During separation of a further workpiece, for each specified separation step (see the third sub-step 106), the above-mentioned sub-steps from the sixth sub-step 112 to the fourteenth sub-step 128 are carried out. In this case, the further workpiece is used instead of the workpiece 14. At the start of execution of the specified separation steps, in the sixth sub-step 112, the readjustment values of the control parameters are stored in the machine controller 36, which, as described above, were calculated in the eighteenth sub-step 136 using the prediction model 44 after the separation of the workpiece 14.

The prediction model 44 can be trained by the following steps, in particular before the specified separation steps for separating the workpiece 14 are carried out: first, a test workpiece is provided, and initial parameter values of the workpiece parameters of the test workpiece are determined. Furthermore, the initial parameter values of the control parameters of the manufacturing means 18 are determined before a subsequent separation of the workpiece 14. Weights in the prediction model 44 in the form of a neural network are initialized. The test workpiece is then separated in such a way that the first parameter values of the workpiece parameters are changed to the second parameter values of the workpiece parameters. The second parameter values can be specified. Alternatively or additionally, the second parameter values of the workpiece parameters can be measured after the separation. After separation of the test workpiece, the parameter values of the control parameters are measured.

The prediction model 44 predicts parameter values of the control parameters, which are used in the calculation by the prediction model to separate the test workpiece by changing the first parameter values to the second parameter values of the workpiece parameters. The prediction takes into account, in particular, the initial parameter values of the control parameters of the manufacturing means 18. Then, a difference is determined between the parameter values of the control parameters predicted using the prediction model 44 and the parameter values of the control parameters measured after the workpiece 14 has been separated. The weights in the prediction model are updated to minimize this difference. The steps of predicting the parameter values of the control parameters, calculating the difference between the predicted and measured parameter values of the control parameters and updating the weights in the prediction model are repeated until the difference reaches or falls below a specified minimization limit. If necessary, further separation steps can be carried out on the test workpiece and the weights in the prediction model can be updated after each separation step according to the aforementioned method.

The sub-steps from the sixth sub-step 112 to the thirteenth sub-step 126 form a two-stage control 50 of the separating process, wherein neural networks are used in particular for this control. The sub-steps from the sixth sub-step 112 to the fourteenth sub-step 128 form an adaptive part 52 of the separating process. The sub-steps from the sixth sub-step 112 to the eighteenth sub-step 136 form a quality control loop 54 of the separating process.

Alternatively or additionally to at least some of the aforementioned steps for training the prediction model 44, in particular separating the test workpiece (see step iii above) and measuring the parameter values of the control parameters (see step iv above), a simulation can be carried out that simulates the separation of the test workpiece and computationally determines the associated parameter values. Such simulations allow for the consideration of disturbance factors in the separating process, e.g., sheet thickness deviations, material strength variations and wear conditions of the manufacturing means used. The simulations can be carried out, in particular within a sensitivity analysis, in order to preferably create a broad database and to predict the optimal control parameters for possible disturbance factors in the separating process. Such simulations can also be used in particular to determine different forms of the cut surfaces resulting from disturbance factors in the process which are produced in the course of the method.

Viewing all of the figures of the drawing together, the present disclosure relates to a method 100 for readjusting a separating process. In the course of the method 100, a workpiece 14 and workpiece parameters are provided, the workpiece parameters representing properties of the workpiece 14 that are relevant for the separating process. Furthermore, a manufacturing means 18 for separating the workpiece 14 and parameter values of control parameters for controlling the manufacturing means 18 are provided. While a separation step from a group of specified separation steps is carried out, the separating forces and/or travel occurring, in particular of the manufacturing means 18, is/are measured. Actual parameter values of the workpiece parameters are ascertained from the measured separating forces and/or travel using an evaluation model. The actual parameter values of the workpiece parameters are converted into a prediction model 44. The prediction model 44 determines readjustment values of the control parameters in order to minimize the difference between the actual parameter values and the target values of the workpiece parameters during separation of the workpiece 14. The control parameters are set to the readjustment values. The method steps from controlling of the manufacturing means 18 using the adjusted control parameters for separating the workpiece 14 to readjusting of the control parameters are repeated until the specified separation steps have been carried out.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 Separation system

12 Base

14 Workpiece

16 Transport rollers

18 Manufacturing means

20 Punch

22 Cut-out

24 Vertically oriented support

26 Horizontal support

28 Stroke rod

30 Sensor

32 Die

34 Cavity

36 Machine controller

40 Frame

42 Evaluation model

44 Prediction model

46 Cut surface

48 Further prediction model

50 Two-stage control

52 Adaptive part

54 Quality control loop

100 Method according to the present disclosure

102–136 Sub-steps of the method according to the present disclosure invention

1. A method for readjusting a separating process and/or forming process, comprising the steps of:
I. providing a workpiece;
II. providing a manufacturing means for separating the workpiece;
III. providing separation steps for separating the workpiece;
IV. providing parameter values of control parameters for controlling the manufacturing means;
V. providing workpiece parameters for characterizing the workpiece and specifying target values of the workpiece parameters which the workpiece should have after separation;
VI. storing the parameter values of the control parameters in a machine controller;
VII. controlling the manufacturing means by the machine controller based on the control parameters to carry out a separation step from the provided separation steps;
VIII. measuring separating forces and/or travel occurring during separation during the separation step;
IX. evaluating values of the separating forces and/or travel measured in step VIII using an evaluation model to determine actual parameter values of the workpiece parameters for characterizing the workpiece;
X. determining readjustment values of the control parameters based on the actual parameter values of the workpiece parameters determined in step IX using a prediction model, such that, within a framework of a calculation by the prediction model, the readjustment values of the control parameters during separation of the workpiece minimize a difference between the target values of the workpiece parameters and the actual parameter values of the workpiece parameters of the workpiece, the difference being determined after the provided separation steps have been carried out;
XI. readjusting the control parameters to the readjustment values; and
XII. repeating steps VI to XI until the provided separation steps have been carried out.

2. The method according to claim 1, wherein after step XII the following steps are carried out:
XIII. measuring the actual parameter values of the workpiece parameters of the workpiece;
XIV. determining differences between the measured actual parameter values of the workpiece parameters and the target values of the workpiece parameters;
XV. determining the readjustment values of the control parameters based on the differences determined in step XIV using the prediction model, such that, within the framework of the calculation by the prediction model, the readjustment values of the control parameters during separation according to the provided separation steps minimize a difference between the target values of the workpiece parameters and the actual parameter values of the workpiece parameters, the difference being determined after the provided separation steps have been carried out;
XVI. readjusting the control parameters to the readjustment values;
XVII. carrying out steps I to XII, wherein, in step I, a further workpiece is provided and, in step IV, the control parameters readjusted to the readjustment values in step XVI are provided.

3. The method according to claim 1, wherein the workpiece parameters have flatness parameters to characterize a flatness of the workpiece, wherein the target values of the flatness parameters have desired parameter values of the flatness parameters to achieve a desired flatness of the workpiece after the provided separation steps have been carried out.

4. The method according to claim 1, wherein the prediction model has a multi-layer perceptron neural network.

5. The method according to claim 4, wherein the prediction model is trained in the following steps:
i. determining first parameter values of the workpiece parameters of a test workpiece and determining parameter values of the control parameters before the subsequent step, step ii, is carried out;
ii. initializing weights in the prediction model;
iii. separating the test workpiece by means of the manufacturing means by changing the first parameter values to second parameter values of the workpiece parameters;
iv. measuring the parameter values of the control parameters after step iii has been carried out;
v. calculating predicted parameter values of the control parameters for separating the test workpiece by changing the first parameter values to the second parameter values of the workpiece parameters using the prediction model;
vi. calculating the difference between the predicted parameter values of the control parameters and the parameter values of the control parameters measured in step iv;
vii. updating the weights in the prediction model to minimize the difference according to step vi;
viii. repeating steps v to vii until a defect according to step vi reaches a specified minimization limit.

6. The method according to claim 1, wherein the evaluation model comprises an algorithm for evaluating the separating forces and/or travel measured during separation of the workpiece, a decision tree, a decision forest, and/or a neural network to classify the workpiece into a workpiece class belonging to specified workpiece classes and/or to classify the manufacturing means into a manufacturing means class belonging to specified manufacturing means classes.

7. The method according to claim 1, wherein the evaluation model is selected from a group of evaluation models on the basis of the parameter values of the control parameters provided in step III and/or on the basis of the parameter values of the workpiece parameters provided in step IV.

8. The method according to claim 1, wherein, before step X, the prediction model is selected from a group of prediction models, in particular on the basis of the parameter values of the control parameters provided in step III and/or on the basis of the parameter values of the workpiece parameters provided in step IV.

9. The method according to claim 1, wherein, before step X, the machine controller compares the parameter values determined in step IX with target values of the control parameters and/or workpiece parameters.

10. The method according to claim 1, wherein the control parameters comprise a force with which the manufacturing means acts on the workpiece, geometric parameters of the manufacturing means, and/or path parameters of a path on which the manufacturing means is guided.

11. The method according to claim 1, wherein the workpiece parameters comprise material parameters of a material of the workpiece, geometric parameters of the workpiece comprising a thickness of the workpiece, and/or a shear strength of the workpiece.

12. The method according to claim 1, wherein the workpiece parameters comprise cut surface parameters to characterize a quality of a cut surface, the target values comprising desired parameter values of the cut surface parameters for a desired quality of the cut surface, wherein, in step X, readjustment values of the control parameters are determined based on the parameter values of the workpiece parameters determined in step IX using the prediction model or a further prediction model such that a difference between the target values of the cut surface parameters and the parameter values of the cut surface parameters of the workpiece is minimized after the provided separation steps have been carried out.

13. The method according to claim 1, wherein the separating process and/or forming process is designed as a punching process.
